(19) United States
(12) Patent Application Publication
(10) Pub. No.: US 2005/0144278 A1
(43) Pub. Date: Jun. 30, 2005

(54) System and method for multipart response optimization

(76) Inventor: Valeri Atamaniouk, Helsinki (FI)

Correspondence Address: CRAWFORD MAUNU PLLC, 1270 NORTHLAND DRIVE, SUITE 390, ST. PAUL, MN, 55120, US

(21) Appl. No.: 10/735,586

(22) Filed: Dec. 12, 2003

(51) Int. Cl. G06F 15/173

(52) U.S. Cl. 709/225

(57) ABSTRACT

A system and method for optimizing multipart responses within a server-client protocol through additional header information provided to signal a multipart response. A server determines whether a multipart response is applicable and generates a single part response having multipart indication to signal the client that a multipart response will follow. The client may then submit a subsequent request for the multipart response by providing an expectation within a request header.

### FIELD OF THE INVENTION

This invention relates in general to client-server protocol, and more particularly, to client-server protocol that incorporates multipart response optimization.

### BACKGROUND OF THE INVENTION

The mobile industry has experienced a period of exceptional growth during the past several years, where mobile voice and simple Short Message Service (SMS) text messaging have provided the primary drivers for this growth. The next wave of growth is expected to come from new mobile services where content, not just voice, will be mobilized. To insure a successful launch of these new mobile services, service enablers are used to create the mobile services according to at least the following criteria: enablement of new and better services for consumers; provision of facilities to developers to speed up the development of the mobile services; and insuring interoperability through the use of open global standards.

The use of open global standards, such as those endorsed by the Open Mobile Alliance (OMA), minimizes fragmentation of the service enablers and insures seamless interoperability between different vendors. Some of the key service enablers used for the successful take-up of the mobile services include: Multimedia Messaging Service (MMS); Mobile Digital Rights Management (MDRM); and mobile browsing, to name only a few. The essence of mobile browsing lies in its close alignment with widely accepted internet standards. The Wireless Application Protocol (WAP) Forum and the World Wide Web Consortium (W3C) have successfully defined mobile internet standards over the past several years. Just recently, the WAP Forum has adopted the Extensible HyperText Markup Language (XHTML) Basic standard from the W3C as the basis for the latest revision of WAP. Even more recently, style tag additions to XHTML Basic, have yielded XHTML Mobile Profile (MP), thus strengthening the position of the mobile browser in the mainstream Internet to allow for a far greater range of presentation and formatting than previously possible. According to the W3C specification, XHTML MP defines a document type that is rich enough to be used for content authoring and precise document layout, yet can be shared across different classes of devices, such as desktop computers, Personal Digital Assistants (PDA), TV, mobile devices, etc.

Whether Internet browsing is facilitated through a WAP enabled mobile terminal or a through a stationary desktop computer, standard Internet protocols such as HyperText Transport Protocol (HTTP) and Transmission Control Protocol (TCP) are required to facilitate the browsing experience. Generally speaking, therefore, a browsing terminal may be considered to be an HTTP client, whereas the content server being accessed during the browsing session may be considered an HTTP server. The HTTP client sends headers that contain target Uniform Resource Locators (URL), a list of acceptable Multipurpose Internet Mail Extensions (MIME) along with other information. In return, the HTTP client expects that the HTTP server will respond with data that matches the request.

There may exist one or more HTTP proxies/gateways between the HTTP client and the HTTP server that are used to provide various services during the browsing session. The HTTP proxy/gateway is visible as a server to the HTTP client, whereas the HTTP proxy/gateway is visible as a client to the HTTP server. One such HTTP proxy/gateway is a Performance Enhancing Proxy (PEP), which may be used to reduce the number of required roundtrips between the HTTP client and the HTTP server. For example, the PEP may execute the HTTP client's request, parse the response from the HTTP server and generate a singe multipart message as a response to the HTTP client. Further performance enhancing techniques may be employed by the HTTP client, whereby the Web page is requested and any referenced resources that are linked by the Web page are requested simultaneously in parallel. In such a case, the total download time would be reduced, provided that sufficient bandwidth exists to support such a parallel download.

When a PEP is used in the chain, however, an increase in the display time for the first page is necessitated due to the related embedded images, Cascadable Style Sheets (CSS), and other objects that are present in the multipart response. A conventional PEP may, therefore, provide a single part content for the first page, while creating a multipart content for the subsequent request. In the case where the HTTP client makes several simultaneous requests in parallel, however, a situation exists such that actual network bandwidth is wasted due to sub-optimal responses. In such a configuration, for example, each of the HTTP client's parallel requests would trigger a multipart response from the PEP, thus needlessly increasing the download time and network bandwidth required during the browsing session.

Accordingly, there is a need in the communications industry for a system and method that optimizes the client-server communication protocol by decreasing the first page to display time, while decreasing the total download time and network bandwidth required during the browsing session.

### SUMMARY OF THE INVENTION

To overcome limitations in the prior art, and to overcome other limitations that will become apparent upon reading and understanding the present specification, the present invention discloses a system and method for multipart response optimization within a client-server protocol.

In accordance with one embodiment of the invention, a communication system is optimized for multipart responses. The communication system comprises a client that is adapted to request content from the communication system. The request for content includes an indicator that a multipart response is desired. The communication system further comprises a proxy that is coupled to receive the request for content and is adapted to access the communication system for the requested content. The communication system further comprises a server that is coupled to the proxy to provide the requested content. The proxy is adapted to provide a single part response to the client, where the single part response includes an indicator to signal a subsequent multipart response that is related to the single part response.

In accordance with another embodiment of the invention, a method for multipart response optimization comprises generating a first request for content, where the first request includes a multipart response expectation indicator. The method further comprises generating a first response to the first request for content, where the first response includes a multipart response capability. The method further comprises generating a second request for content and generating a second response to the second request for content, wherein the second response includes a format that is indicative of the multipart response capability indicator.

In accordance with another embodiment of the invention, a mobile terminal is wirelessly coupled to a network, where the network includes a proxy coupled to the network. The mobile terminal comprises a memory that is capable of storing at least a multipart header module, a processor coupled to the memory and is configured by the multipart header module to generate content requests having a multipart response expectation indicator. The mobile terminal further comprises a transceiver configured to facilitate a content response exchange with the proxy. The multipart header module is further configured to search the content response for a multipart capability indicator.

In accordance with another embodiment of the invention, a computer-readable medium having instructions stored thereon which are executable by a mobile terminal for requesting optimized multipart response handling in a network is provided. The instructions performing the steps of supplying a multipart expectation indicator in a content request, receiving a content response to the content request, examining the content response for a multipart capability indication, and precluding transmission of parallel content requests when the multipart capability indication exists within the content response.

In accordance with another embodiment of the invention, a proxy is coupled to a network to detect multipart content requests. The proxy comprises means for receiving a first content request, means for determining the existence of a multipart response expectation indicator, means for generating a single part response in response to the existence of the multipart response expectation indicator in the first content request, and means for generating a multipart response after a second content request is received, where the multipart response is related to the single part response.

In accordance with another embodiment of the invention, a computer-readable medium having instructions stored thereon which are executable by a proxy is provided. The instructions perform steps comprising receiving a first content request, determining the existence of a multipart response expectation indicator, generating a single part response in response to the existence of the multipart response expectation indicator in the first content request, and generating a multipart response after a second content request is received, where the multipart response is related to the single part response.

These and various other advantages and features of novelty which characterize the invention are pointed out with greater particularity in the claims annexed hereto and form a part hereof. However, for a better understanding of the invention, its advantages, and the objects obtained by its use, reference should be made to the drawings which form a further part hereof, and to accompanying descriptive matter, in which there are illustrated and described specific examples of a system, apparatus, and method in accordance with the invention.

### BRIEF DESCRIPTION OF THE DRAWINGS

The invention is described in connection with the embodiments illustrated in the following diagrams.

FIG. 1 illustrates an exemplary communication system in which the principles of the present invention may be utilized;

FIG. 2 illustrates a message flow diagram in accordance with the principles of the present invention;

FIG. 3 illustrates an exemplary HyperText Transfer Protocol (HTTP) response in accordance with the present invention;

FIG. 4 illustrates an exemplary HyperText Transfer Protocol (HTTP) request in accordance with the present invention;

FIG. 5 illustrates an exemplary flow diagram in accordance with the present invention;

FIG. 6 illustrates a representative mobile computing arrangement suitable for optimized multipart response functionality in accordance with the present invention; and

FIG. 7 is a representative computing system capable of carrying out server related functions associated with optimized response optimization according to the present invention.

### DETAILED DESCRIPTION OF THE INVENTION

In the following description of the exemplary embodiment, reference is made to the accompanying drawings which form a part hereof, and in which is shown by way of illustration various embodiments in which the invention may be practiced. It is to be understood that other embodiments may be utilized, as structural and operational changes may be made without departing from the scope of the present invention.

Generally, the present invention is directed to a system and method that provides multipart response optimization. Multipart optimization during an HTTP request/response transaction, for example, may be accomplished through the cooperation of the HTTP client and the HTTP server. If the HTTP request of particular content could yield a multipart response, then the HTTP server provides the HTTP client with a single part response that contains a multipart indication in the header. In particular, the multipart indication signals the HTTP client that the next request may yield a multipart response and that there is no need to execute parallel requests. Accordingly, a reduction in the first page to display is realized, since the first page is not encumbered with embedded images or CSS. Additionally, the use of parallel requests is obviated, since the HTTP client/server pair utilize header information to signal their multipart expectations/capabilities.

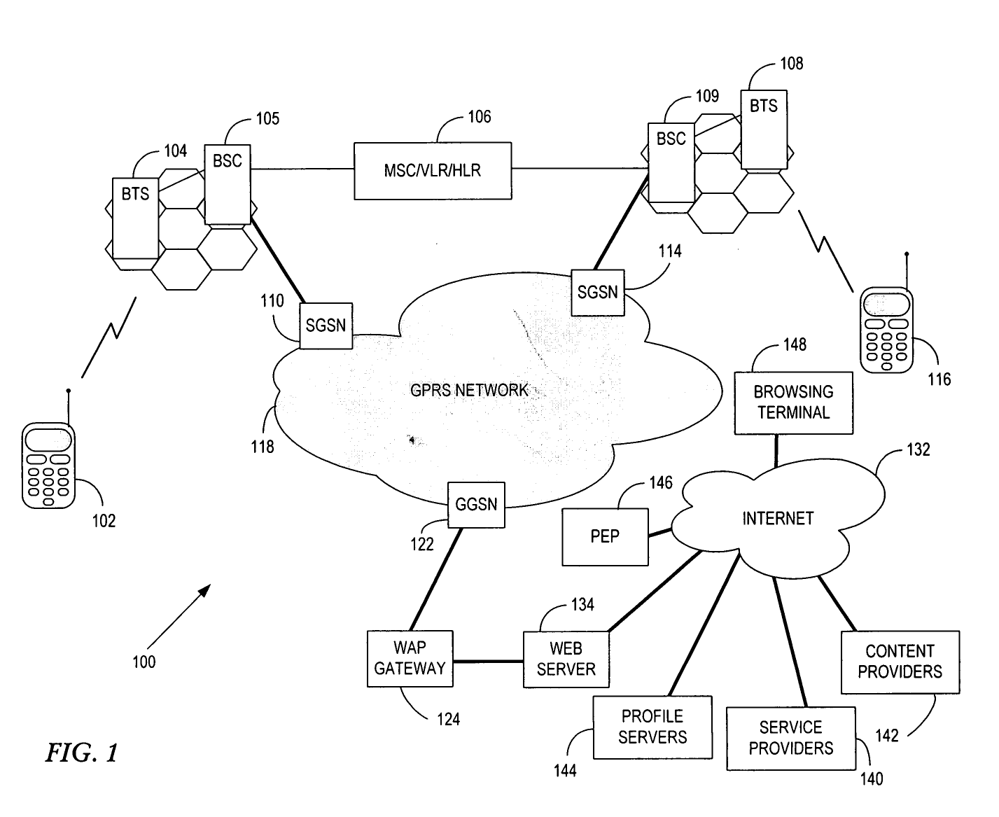

FIG. 1 illustrates exemplary communication system 100 in which the principles of the present invention may be utilized. Communication system 100 utilizes General Packet Radio Service (GPRS) network 118 as the communications backbone. GPRS is a packet-switched service for the Global System for Mobile Communications (GSM) that mirrors the Internet model and enables seamless transition towards 3G (third generation) networks. GPRS thus provides actual packet radio access for mobile GSM and time-division multiple access (TDMA) users, and is ideal for Wireless Application Protocol (WAP) services. While the exemplary embodiments of FIG. 1 are generally described in connection with GPRS/GSM, it should be recognized that the specific references to GSM and GPRS are provided to facilitate an understanding of the invention. As will be readily apparent to those skilled in the art from the description provided herein, the invention is equally applicable to other technologies, including other circuit-switched and packet-switched technologies, 3G technologies, and beyond.

Referring to FIG. 1, mobile terminals 102 and 116 communicate with Base Transceiver Station (BTS) 104 and 108, respectively, via an air interface. BTS 104 and 108 are components of the wireless network access infrastructure that terminates the air interface over which subscriber traffic is communicated to and from mobile terminals 102 and 116. Base Station Controller (BSC) 105 and 109 are switching modules that provide, among other things, handoff functions, and power level control in each BTS 104 and 108, respectively. BSC 105 and 109 controls the interface between a Mobile Switching Center (MSC) 106 and BTS 104 and 108, and thus controls one or more BTSs in the call set-up functions, signaling, and use of radio channels. BSC 105 and 109 also controls the respective interfaces between Serving GPRS Support Node (SGSN) 110 and BTS 104 and SGSN 114 and BTS 108.

SGSN 110 serves a GPRS mobile terminal by sending or receiving packets via a Base Station Subsystem (BSS), and more particularly via BSC 105 and 109 in the context of GSM systems. SGSN 110 and 114 are responsible for the delivery of data packets to and from mobile terminals 102 and 116, respectively, within the service area, and they perform packet routing and transfer, mobility management, logical link management, authentication, charging functions, etc. In the exemplary GPRS embodiment shown in FIG. 1, the location register of SGSN 110 stores location information such as the current cell and Visiting Location Register (VLR) associated with mobile terminal 102, as well as user profiles such as the International Mobile Subscriber Identity Number (IMSI) of all GPRS users registered with SGSN 110. SGSN 114 performs similar functions relating to mobile terminal 116. While GSM forms the underlying technology, SGSN 110 and 114 described above are network elements introduced through GPRS technology. Another network element introduced in the GPRS context is the Gateway GPRS Support Node (GGSN) 122, which acts as a gateway between the GPRS network 118 and WAP gateway 124. Access to Internet 132 and corresponding service and content providers, 140 and 142 respectively, is provided to mobile terminals 102 and 116 via Web server 134. Profile servers 144 may provide profile information to Internet 132 in relation to hardware/software capabilities pertaining to mobile terminals 102 and 116.

WAP enhances the functionality of mobile terminals through real-time interactive services. The protocol has been specifically designed for small screens and low bandwidths, and it offers a wide variety of wireless services over the Internet for mobile devices. It was also designed to allow content to be delivered over any bearer service, even when delivery of the services is enabled over GPRS, 3G, or any other type of network. WAP over GPRS opens up new possibilities for application development and there are also some optimizations in GPRS that can be performed by service developers.

Application developers can use the principles of WAP to develop new services or adapt existing Internet applications for use with mobile devices. Applications are written, for example, in Wireless Markup Language (WML) and WMLScript (WMLS) and are stored on either Web server 134 or directly on WAP gateway 124. The content stored on Web server 134 is accessible from mobile devices 102 and 116 via GPRS network 118, GGSN 122, and WAP gateway 124. It is recommended to use an HTTP proxy, e.g., PEP 146, to cache WML content whenever the content is accessed via Internet 132.

Mobile devices 102 and 116 access WAP gateway 124 using a GSM data call, where they supply a user-agent field within a Wireless Session Protocol (WSP) header when fetching content from Web server 134. WAP gateway 124 then encapsulates the WSP header within an HTTP header prior to sending to Web server 134. The WSP header is utilized by Web server 134, for example, to determine the particular browser that is being utilized by mobile devices 102 and 116, so that context dependent content may be delivered to mobile devices 102 and 116 by Web server 134.

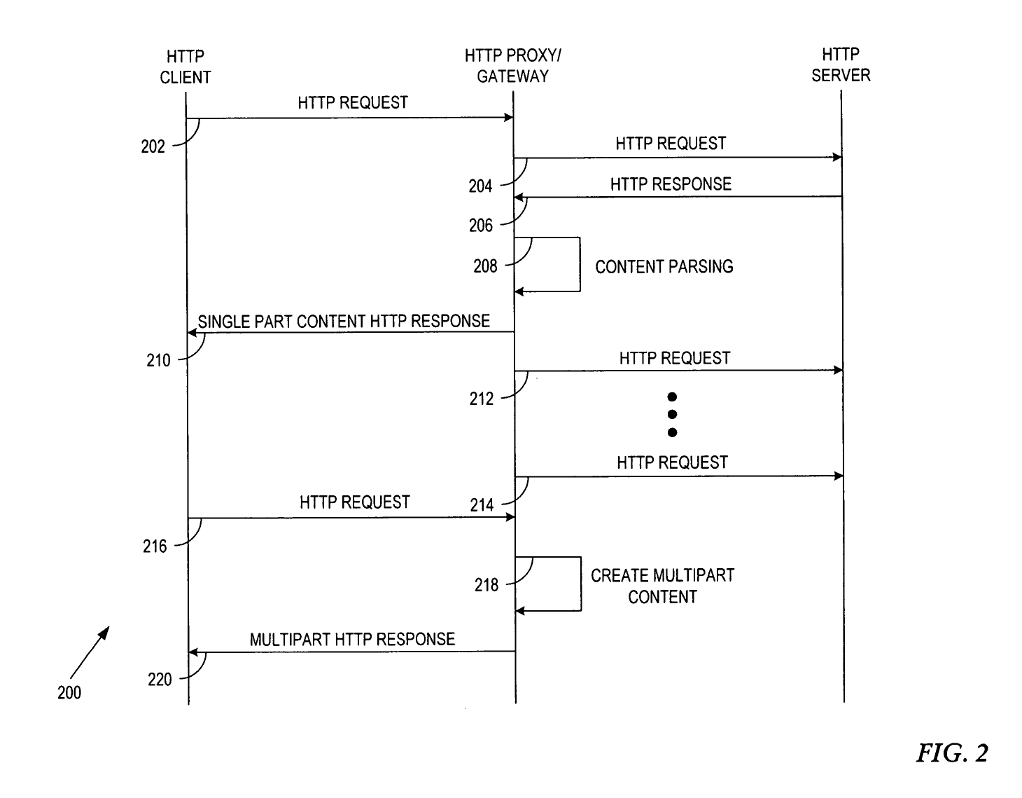

It should be noted that while the present invention may be used to optimize client-server interactions between mobile devices 102 and 116, service and content providers 140-142, and PEP 146, conventional browsing between PEP 146, browsing terminal 148, and service and content providers 140-142 may be enhanced according to the present invention to establish multipart response optimization for conventional Internet browsing. Whether the requesting client is mobile, e.g., mobile terminals 102 and 116, or whether the requesting client is stationary, e.g., browsing terminal 148, message flow 200 of FIG. 2 may be used to exemplify one embodiment according to the present invention.

In message 202, a request message is transmitted from HTTP client, e.g., mobile terminal 102/116 or browsing terminal 148 to, for example, PEP 146. The HTTP request message is then forwarded onto HTTP server, e.g., content provider 142, via message 204, which is then followed by response message 206. HTTP response message 206 may contain embedded links to content within Internet 132, which are then parsed by PEP 146 in step 208.

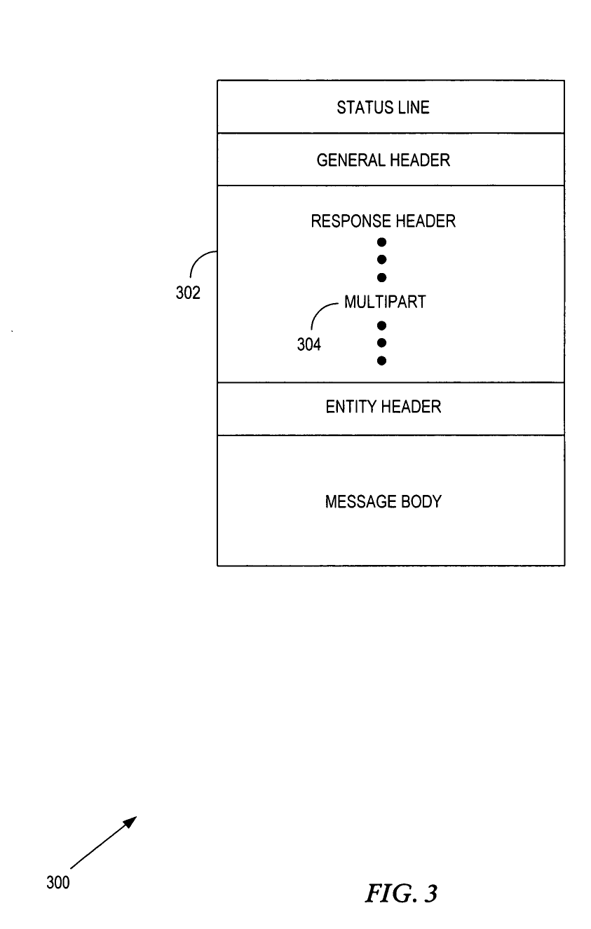

In one embodiment according to the present invention, single part content HTTP response 300 of FIG. 3 may be returned by PEP 146 via message 210. In particular, response header 302 may contain an identifier, e.g., Multipart 304, that indicates to the HTTP client that the next HTTP request may result in a multipart response. In such an instance, the HTTP client is informed, via Multipart 304, that parallel requests will not be necessary. HTTP request messages 212-214 are then executed by PEP 146, so that content represented by the embedded links parsed in step 208 may be received by PEP 146 from the HTTP server. A subsequent request, e.g., HTTP request 216, from the HTTP client may then result in the creation of a multipart message as in step 218, followed by the subsequent delivery of the multipart message in HTTP response 220. Accordingly, the HTTP client has restrained from submitting parallel requests to PEP 146 due to the existence of Multipart 304 within response header 302.

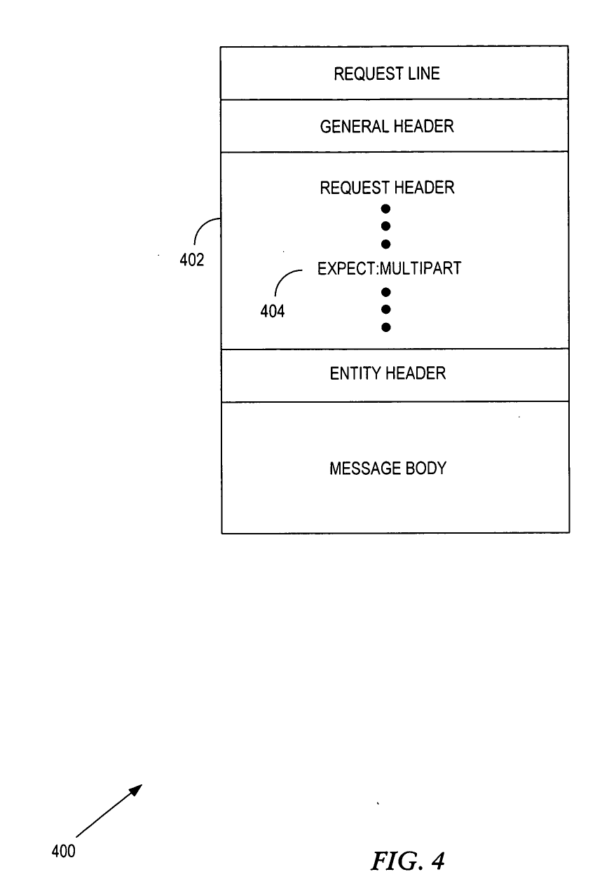

In an alternate embodiment according to the present invention, the HTTP client may respond with HTTP request 400 of FIG. 4 when the Multipart 304 indication within response header 302 has been received. In such an instance, the HTTP client may submit Expect:Multipart 404 within request header 402 in order to signal PEP 146 that a multipart response message is expected.

In yet another embodiment according to the present invention, the HTTP client may indicate an expectation that a response to the request would be a multipart response. If the subsequent response from the HTTP server is a single part response, then the HTTP client then realizes that the HTTP server does not support multipart responses. In such an instance, the HTTP client could then execute parallel requests as necessary to receive the requested content.

In an additional embodiment according to the present invention, the HTTP client may indicate that it accepts multipart responses through the use of the Accept header field, e.g., “Accept”. Furthermore, the HTTP client may indicate that it prefers multipart responses through the use of the q-value associated with the Accept header field. For example, the HTTP client may indicate that both multipart and single part responses are acceptable, however, the q-value associated with the multipart field of the Accept header is set to a higher value than the q-value associated with the single part field of the Accept header. In this way, the HTTP server knows that multipart responses are preferred over single part responses. In addition, the HTTP server may indicate that it can provide multipart data through the use of the “Via” general header field. In such an instance, the HTTP client uses the “Via” general header field to detect the HTTP server's multipart capability.

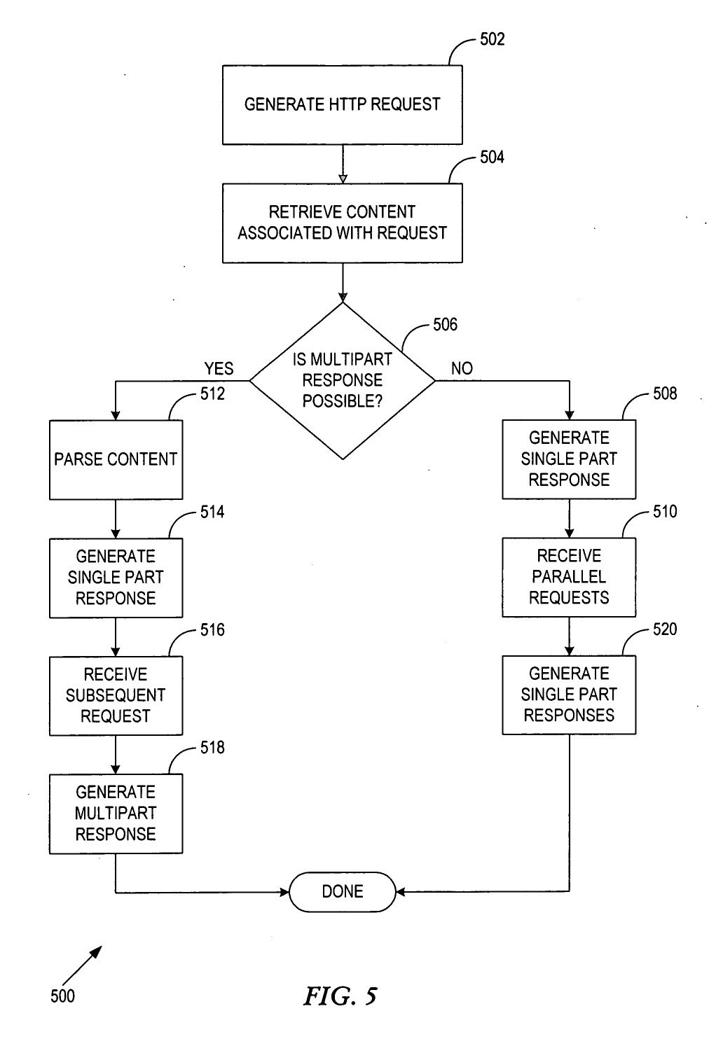

The flow diagram of FIG. 5 illustrates an exemplary method 500 in which an HTTP client/server pair may interact with each other to promote multipart response optimization. In step 502, an HTTP client generates an HTTP request that may be received by an HTTP proxy/gateway. The HTTP request may contain, for example, Expect:Multipart header 404, as displayed in FIG. 4, which indicates the HTTP client's desire to receive multipart content. Content associated with the request is then gathered by the HTTP proxy/gateway in step 504. If multipart responses are not possible for any reason, as verified in step 506, then a single part response is generated by the HTTP proxy/gateway in step 508 that does not contain Multipart 304 of response header 302 as shown in FIG. 3. The HTTP client, having received the single part response in response to a multipart request, then generates parallel requests in step 510 in order to receive the entire content requested in step 502. Subsequent responses to the parallel requests are then generated as in step 520.

If, on the other hand, the HTTP proxy/gateway is able to generate multipart responses in response to the HTTP client's multipart request, then the content retrieved is parsed in step 512 and a generic single part response is generated in step 514 that does contain Multipart 304 of response header 302. The HTTP client, having received the single part response, is now able to quickly display the contents of the response, since the response is not encumbered with various embedded links and objects. The subsequent request of step 516 is then transmitted by the HTTP client to the HTTP proxy/gateway and the multipart response of step 518 is then generated and delivered to the HTTP client to complete the transaction.

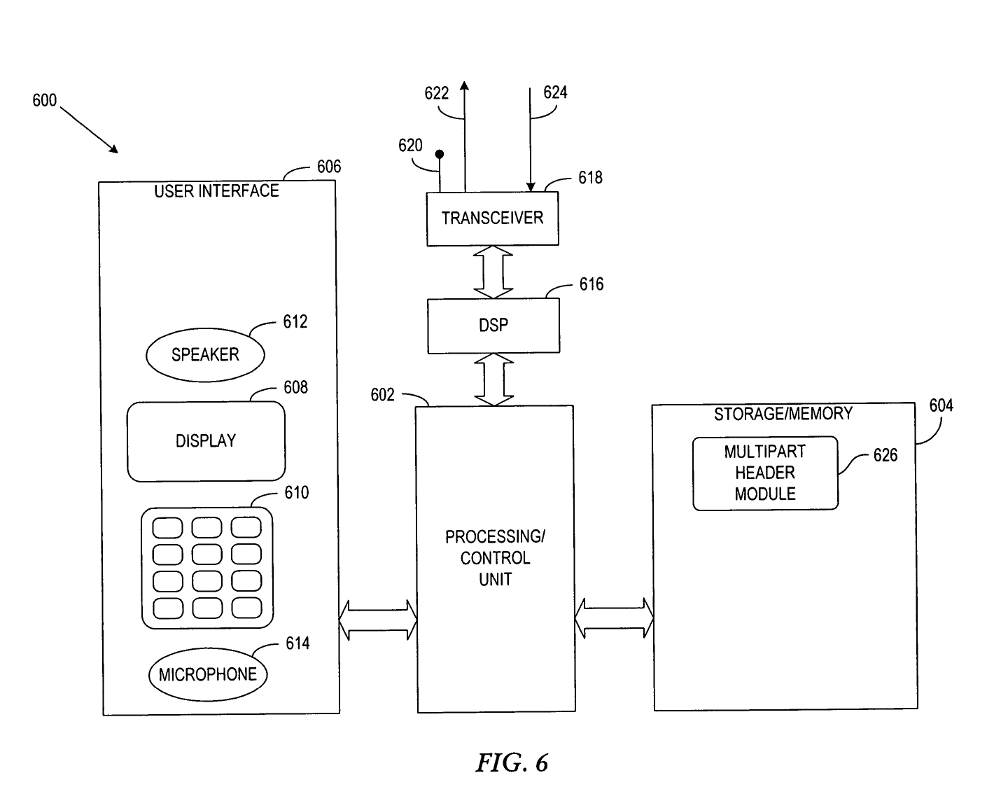

The invention is a modular invention, whereby processing functions within either a mobile terminal or a hardware platform may be utilized to implement the present invention. The mobile terminals may be any type of wireless device, such as wireless/cellular telephones, personal digital assistants (PDAs), or other wireless handsets, as well as portable computing devices capable of wireless communication. These landline and mobile devices utilize computing circuitry and software to control and manage the conventional device activity as well as the functionality provided by the present invention. Hardware, firmware, software or a combination thereof may be used to perform the various multipart response optimization functions described herein. An example of a representative mobile terminal computing system capable of carrying out operations in accordance with the invention is illustrated in FIG. 6. Those skilled in the art will appreciate that the exemplary mobile computing environment 600 is merely representative of general functions that may be associated with such mobile devices, and also that landline computing systems similarly include computing circuitry to perform such operations.

The exemplary mobile computing arrangement 600 suitable for multipart response optimization functions in accordance with the present invention may be associated with a number of different types of wireless devices. The representative mobile computing arrangement 600 includes a processing/control unit 602, such as a microprocessor, reduced instruction set computer (RISC), or other central processing module. The processing unit 602 need not be a single device, and may include one or more processors. For example, the processing unit may include a master processor and associated slave processors coupled to communicate with the master processor.

The processing unit 602 controls the basic functions of the mobile terminal, and also those functions associated with the present invention as dictated by multipart header module 626 available in the program storage/memory 604. Thus, the processing unit 602 is capable of requesting multipart responses as well as reviewing header portions of received responses to determine if multipart responses can be expected from participating HTTP servers or proxies. The program storage/memory 604 may also include an operating system and program modules for carrying out functions and applications on the mobile terminal. For example, the program storage may include one or more of read-only memory (ROM), flash ROM, programmable and/or erasable ROM, random access memory (RAM), subscriber interface module (SIM), wireless interface module (WIM), smart card, or other removable memory device, etc.

In one embodiment of the invention, the program modules associated with the storage/memory 604 are stored in non-volatile electrically-erasable, programmable ROM (EEPROM), flash ROM, etc. so that the information is not lost upon power down of the mobile terminal. The relevant software for carrying out conventional mobile terminal operations and operations in accordance with the present invention may also be transmitted to the mobile computing arrangement 600 via data signals, such as being downloaded electronically via one or more networks, such as the Internet and an intermediate wireless network(s).

The processor 602 is also coupled to user-interface 606 elements associated with the mobile terminal. The user-interface 606 of the mobile terminal may include, for example, a display 608 such as a liquid crystal display, a keypad 610, speaker 612, and microphone 614. These and other user-interface components are coupled to the processor 602 as is known in the art. Other user-interface mechanisms may be employed, such as voice commands, switches, touch pad/screen, graphical user interface using a pointing device, trackball, joystick, or any other user interface mechanism.

The mobile computing arrangement 600 also includes conventional circuitry for performing wireless transmissions. A digital signal processor (DSP) 616 may be employed to perform a variety of functions, including analog-to-digital (A/D) conversion, digital-to-analog (D/A) conversion, speech coding/decoding, encryption/decryption, error detection and correction, bit stream translation, filtering, etc. The transceiver 618, generally coupled to an antenna 620, transmits the outgoing radio signals 622 and receives the incoming radio signals 624 associated with the wireless device.

The mobile computing arrangement 600 of FIG. 6 is provided as a representative example of a computing environment in which the principles of the present invention may be applied. From the description provided herein, those skilled in the art will appreciate that the present invention is equally applicable in a variety of other currently known and future mobile and landline computing environments. For example, desktop computing devices similarly include a processor, memory, a user interface, and data communication circuitry. Thus, the present invention is applicable in any known computing structure where data may be communicated via a network.

Using the description provided herein, the invention may be implemented as a machine, process, or article of manufacture by using standard programming and/or engineering techniques to produce programming software, firmware, hardware or any combination thereof. Any resulting program(s), having computer-readable program code, may be embodied on one or more computer-usable media, such as disks, optical disks, removable memory devices, semiconductor memories such as RAM, ROM, PROMS, etc. Articles of manufacture encompassing code to carry out functions associated with the present invention are intended to encompass a computer program that exists permanently or temporarily on any computer-usable medium or in any transmitting medium which transmits such a program. Transmitting mediums include, but are not limited to, transmissions via wireless/radio wave communication networks, the Internet, intranets, telephone/modem-based network communication, hard-wired/cabled communication network, satellite communication, and other stationary or mobile network systems/communication links. From the description provided herein, those skilled in the art will be readily able to combine software created as described with appropriate general purpose or special purpose computer hardware to create a multipart response optimization system and method in accordance with the present invention.

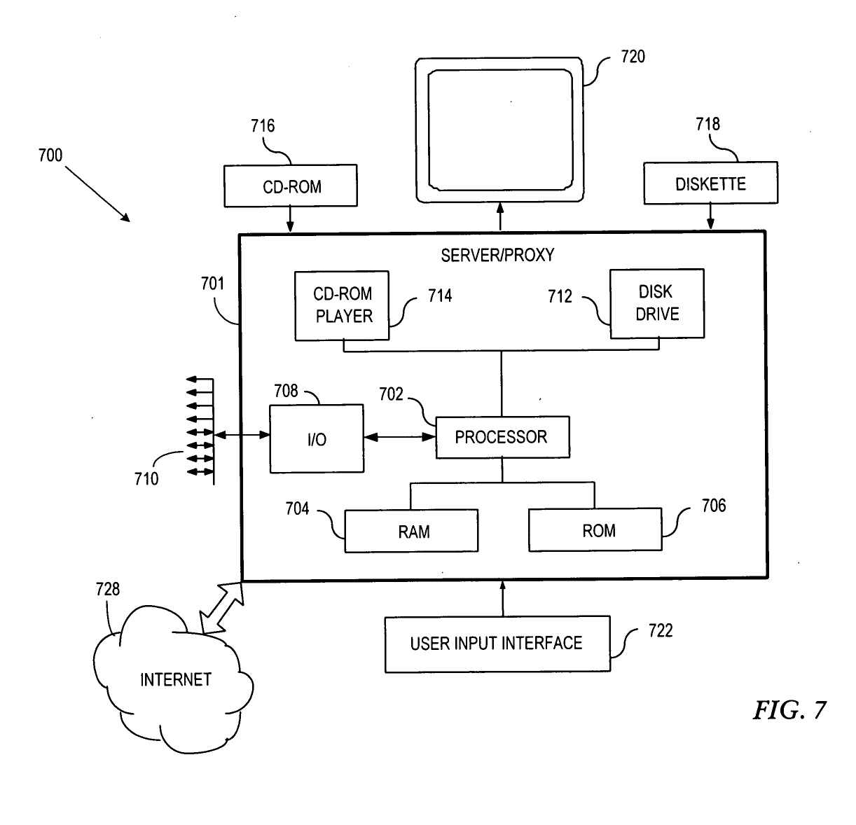

The HTTP proxies/servers or other systems for providing server functions in connection with the present invention may be any type of computing device capable of processing and communicating digital information. The server platforms utilize computing systems to control and manage the multipart response optimization activity. An example of a representative computing system capable of carrying out operations in accordance with the invention is illustrated in FIG. 7. Hardware, firmware, software or a combination thereof may be used to perform the various optimization functions and operations described herein. The computing structure 700 of FIG. 7 is an example computing structure that can be used in connection with such a multipart response optimization platform.

The example computing arrangement 700 suitable for performing the optimization activity in accordance with the present invention includes server/proxy 701, which includes a central processor (CPU) 702 coupled to random access memory (RAM) 704 and read-only memory (ROM) 706. The ROM 706 may also be other types of storage media to store programs, such as programmable ROM (PROM), erasable PROM (EPROM), etc. The processor 702 may communicate with other internal and external components through input/output (I/O) circuitry 708 and bussing 710, to provide control signals and the like. For example, data received from I/O connections 708 or Internet connection 728 may be processed in accordance with the present invention to, for example, search for the existence of a multipart response expectation indicator in content requests received. External data storage devices, such as profile/capability servers, may be coupled to I/O circuitry 708 to facilitate optimization functions according to the present invention. Alternatively, such databases may be locally stored in the storage/memory of server/proxy 701, or otherwise accessible via a local network or networks having a more extensive reach such as the Internet 728. The processor 702 carries out a variety of functions as is known in the art, as dictated by software and/or firmware instructions.

Server/proxy 701 may also include one or more data storage devices, including hard and floppy disk drives 712, CD-ROM drives 714, and other hardware capable of reading and/or storing information such as DVD, etc. Disk drives 712 may, for example, provide storage cache for previously parsed content for future content requests from terminals having multipart optimization capabilities. In one embodiment, software for carrying out the multipart response optimization operations in accordance with the present invention may be stored and distributed on a CD-ROM 716, diskette 718 or other form of media capable of portably storing information. These storage media may be inserted into, and read by, devices such as the CD-ROM drive 714, the disk drive 712, etc. The software may also be transmitted to server/proxy 701 via data signals, such as being downloaded electronically via a network, such as the Internet. Server/proxy 701 is coupled to a display 720, which may be any type of known display or presentation screen, such as LCD displays, plasma display, cathode ray tubes (CRT), etc. A user input interface 722 is provided, including one or more user interface mechanisms such as a mouse, keyboard, microphone, touch pad, touch screen, voice-recognition system, etc.

Server/proxy 701 may be coupled to other computing devices, such as the landline and/or wireless terminals via a network. The server may be part of a larger network configuration as in a global area network (GAN) such as the Internet 728, which allows ultimate connection to the various landline and/or mobile client/watcher devices.

The foregoing description of the various embodiments of the invention has been presented for the purposes of illustration and description. It is not intended to be exhaustive or to limit the invention to the precise form disclosed. Many modifications and variations are possible in light of the above teaching. Thus, it is intended that the scope of the invention be limited not with this detailed description, but rather determined from the claims appended hereto.

1. A communication system optimized for multipart responses, the communication system comprising:
a client adapted to request content from the communication system, the request for content including an indicator that a multipart response is desired;
a proxy coupled to receive the request for content and adapted to access the communication system for the requested content; and
a server coupled to the proxy to provide the requested content, wherein the proxy is adapted to provide a single part response to the client, the single part response including an indicator to signal a subsequent multipart response that is related to the single part response.

2. The communication system according to claim 1, wherein the request for content comprises a HyperText Transfer Protocol (HTTP) request having a request header.

3. The communication system according to claim 2, wherein the request header includes the indicator that a multipart response is desired.

4. The communication system according to claim 1, wherein the single part response comprises a HyperText Transfer Protocol (HTTP) response having a response header.

5. The communication system according to claim 4, wherein the response header includes the indicator that a multipart response will be subsequently transmitted.

6. A method for multipart response optimization, comprising:
generating a first request for content, the first request including a multipart response expectation indicator;
generating a first response to the first request for content, the first response including a multipart response capability;
generating a second request for content; and
generating a second response to the second request for content, wherein the second response includes a format that is indicative of the multipart response capability indicator.

7. The method according to claim 6, wherein a lack of multipart response capability is signalled by an absence of a multipart response capability indicator.

8. The method according to claim 7, wherein the second request for content is one of a plurality of parallel requests for single part content.

9. The method according to claim 6, wherein support for the multipart response capability is signalled by a multipart response capability indicator.

10. The method according to claim 9, wherein the second request for content is a single request for multipart content.

11. A mobile terminal wirelessly coupled to a network which includes a proxy coupled to the network, the mobile terminal comprising:
a memory capable of storing at least a multipart header module;
a processor coupled to the memory and configured by the multipart header module to generate content requests having a multipart response expectation indicator; and
a transceiver configured to facilitate a content response exchange with the proxy, wherein the multipart header module is further configured to search the content response for a multipart capability indicator.

12. The mobile terminal according to claim 11, wherein existence of the multipart capability indicator in the content response precludes generation of parallel content requests from the processor.

13. A computer-readable medium having instructions stored thereon which are executable by a mobile terminal for requesting optimized multipart response handling in a network by performing steps comprising:
supplying a multipart expectation indicator in a content request;
receiving a content response to the content request;
examining the content response for a multipart capability indication; and
precluding transmission of parallel content requests when the multipart capability indication exists within the content response.

14. A proxy coupled to a network to detect multipart content requests, the proxy comprising:
means for receiving a first content request;
means for determining the existence of a multipart response expectation indicator in the first content request;
means for generating a single part response in response to the existence of the multipart response expectation indicator in the first content request; and
means for generating a multipart response after a second content request is received, the multipart response being related to the single part response.

15. A computer-readable medium having instructions stored thereon which are executable by a proxy by performing steps comprising:
receiving a first content request;
determining the existence of a multipart response expectation indicator in the first content request;
generating a single part response in response to the existence of the multipart response expectation indicator in the first content request; and
generating a multipart response after a second content request is received, the multipart response being related to the single part response.
